(19) United States
(12) Patent Application Publication
(10) Pub. No.: US 2012/0133733 A1
(43) Pub. Date: May 31, 2012

(54) THREE-DIMENSIONAL VIDEO IMAGE PROCESSING DEVICE, THREE-DIMENSIONAL DISPLAY DEVICE, THREE-DIMENSIONAL VIDEO IMAGE PROCESSING METHOD AND RECEIVING DEVICE

(76) Inventors: Hidenori SAKANIWA, Yokohama (JP); Masahiro OGINO, Ebina (JP); Nobuhiro FUKUDA, Tokyo (JP); Minoru HASEGAWA, Fujisawa (JP)

(21) Appl. No.: 13/286,414

(22) Filed: Nov. 1, 2011

(30) Foreign Application Priority Data
Nov. 26, 2010 (JP) 2010-263077
Sep. 26, 2011 (JP) 2011-208405

(51) Int. Cl. H04N 13/00

(52) U.S. Cl. 348/43

(57) ABSTRACT

A three-dimensional video image processing device includes an input unit for receiving a video image, an analysis unit for generating a histogram of a color space for each of a left and right eye video image contained in the video image to detect a feature parameter for each of the video images, and a correction unit for implementing a correction on the color space, for reducing a difference of the feature parameter of the left eye video image and the feature parameter of the right eye video image detected in the analysis unit, thereby preferably correcting a color deviation on the left and right video image of a three-dimensional video image.

### INCORPORATION BY REFERENCE

The present application claims priorities from Japanese applications JP 2010-263077 filed on Nov. 26, 2010, and JP 2011-208405 filed on Sep. 26, 2011, the contents of which are hereby incorporated by reference into this application.

### BACKGROUND OF THE INVENTION

The present invention relates to a color correction technique for three-dimensional video images.

In a generation of the three-dimensional video images, there have been methods of displaying the three-dimensional video images in such a way that two cameras or lenses are prepared for taking video images viewed from the right and left eye to display the video image on a display device at the same time (in polarization system, disparity barrier system, lenticular system, etc.) or along with a time sequence (shutter glasses system). The right and left eye are subject to the left and right video image having the disparity to make the left and right disparity into a three-dimensional image in viewer's brain, therefore, the video image can be viewed three-dimensionally. In such method of generating and displaying the three-dimensional video image, a color shade, value, etc. of each of the video images are sometimes different caused by individual differences in the plural cameras and lenses, an incident amount and incident angle of light, etc. even when the same video images are taken.

In this way, in a condition where there is a difference such as the color shade and value on the left and right video image as a phenomenon acquired from the video images viewed by the left and right eye, there is a probability that a color deviation on the left and right image is large to cause a binocular rivalry and hard to merge the video images with each other, and there is also a probability that the color deviation on the left and right video image causes an eyestrain.

In the method of correcting the left and right image for a three-dimensional display, JP-A-2003-061116 discloses a method of correcting a perpendicular positional deviation of the left and right image. JP-A-02-058993 discloses a correcting method of matching an average brightness level of left and right eye video signal with its dynamic range.

### SUMMARY OF THE INVENTION

However, the technique for correcting the left and right video image disclosed in JP-A-2003-061116 and JP-A-02-058993 does not describe a correction technique regarding the color deviation on the left and right video image. When a video image is taken by plural cameras, the color deviation sometimes occurs caused by a difference of individual camera characteristics, a focus of the cameras, an unfocussed, a difference of adjusting white balance. In this case, the viewer is to see a video image having the color deviation on the right and left eye.

The invention is made in light of the above-mentioned problem, and an object of the invention is to provide preferably correcting the color shade of video image entering the left and right eye.

In order to solve the above-mentioned problem, an aspect of the invention is that a three-dimensional video image processing device is configured by an input unit that receives a video image, an analysis unit that generates a histogram of a color space for each of a left and right eye video image contained in the video image to detect a feature parameter for each of the video images, and a correction unit that implements a correction on the color space, for reducing a difference of the feature parameter of the left eye video image and the feature parameter of the right eye video image detected in the analysis unit.

(Technical Effects)

The color shade of video image entering the left and right eye is corrected preferably in the three-dimensional video image.

The three-dimensional and two-dimensional are hereinafter referred to as 3D and 2D unless otherwise stated.

The other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration example of 3D video image processing device in a first embodiment of the invention;

FIG. 2 is a block diagram showing an example of a left and right color correction processing unit in the first embodiment;

FIG. 3 is an operation sequence of the left and right color correction processing in the left and right color correction processing unit in the first embodiment;

FIG. 4 is an explanatory diagram of HSV color space;

FIG. 5 is an example showing a hue histogram in the left and right color correction processing unit in the first embodiment;

FIG. 6 is an example showing a feature of the hue histogram in the left and right color correction processing unit in the first embodiment;

FIG. 7 is a block diagram showing a configuration example of the 3D video image processing device in a second embodiment of the invention;

FIG. 8 is a diagram showing an example of coordinating a user operation and the left and right color correction processing in the 3D video image processing device in the second embodiment;

FIG. 9 is a block diagram showing a configuration example of the 3D video image processing device in a third embodiment of the invention;

FIG. 10 is an example showing a left and right video image in detecting an occlusion of the 3D video image processing device in the third embodiment;

FIG. 11 is an operation sequence in detecting the occlusion of the 3D video image processing device in the third embodiment;

FIG. 12 is a block diagram showing a configuration example of a receiving device in a fourth embodiment of the invention;

FIG. 13 is an operation sequence of the receiving device in the fourth embodiment;

FIG. 14 is an operation sequence of the receiving device in the fourth embodiment;

FIG. 15 is an operation sequence of the receiving device in the fourth embodiment;

FIG. 16 is an operation sequence of the receiving device in the fourth embodiment; and

FIG. 17 is an operation sequence of the receiving device in the fourth embodiment.

### DESCRIPTION OF THE EMBODIMENTS

Hereinafter, embodiments of the invention will be described with reference to the drawings.

### Embodiment 1

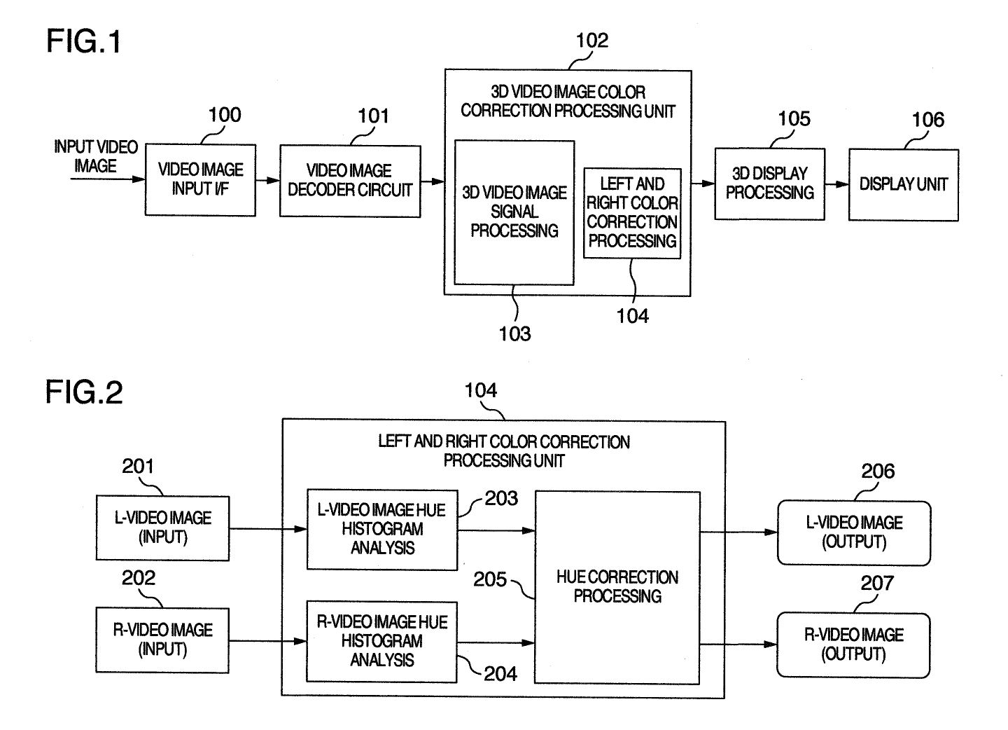

A first embodiment of the invention will be described with reference to FIG. 1 to FIG. 6.

FIG. 1 is a block diagram showing a configuration example of a 3D video image processing device in the first embodiment.

Referring to FIG. 1, a reference numeral 100 denotes a video image input I/F, 101 is a video image decoder circuit, 102 is a 3D video image color correction processing unit, 103 is a 3D video image signal processing unit, 104 is a left and right color correction processing unit, 105 is a 3D display processing unit and 106 is a display unit.

The video image input I/F 100 is an interface of receiving contents such as video images, sound signals, characters, etc. from broadcasts, and player devices and game machines incorporating a disk etc. The video image decoder circuit 101 implements a decode processing etc. for the video image to output a video image signal. The 3D video image signal processing unit 102 implements a video image signal processing for separating the video image corresponding to the left and right eye in the 3D video image processing unit 103, when receiving the 3D video image specified by a Side-by-Side (SBS) system, Top-and-Bottom (TAB) system, Frame-Packing (FP) system, Multi-Eye system, etc. The left and right color correction processing unit 104 implements a color correction, i.e. correction on color spaces, so as to make a color difference of the video images corresponding to the left and right eye small. The 3D display processing unit 105 switches over the video image subjected to the color correction in the left and right color correction processing unit 104 to a left eye video image L or a right eye video image R to output to the display unit 106, and also implements an infrared light signal processing etc. for transmitting a switching-over timing to a shutter glasses. When the 3D display is adapted to a polarized glasses system, a processing is made adapt to a disparity barrier installed on the display unit 106 to implement such that display pixels are adjusted so as to display the video images on the left and right. In a naked eye system, a video image signal processing is implemented to be adapted to a lenticular lens etc. installed on the display unit 106. The display unit 106 is a display using, such as a liquid-crystal device, OLED (Organic Light-Emitting Diode), plasma, etc., to display as a 3D display by switching over the video images on the left and right output from the 3D display processing unit 105 at an adjusted timing, display pixels adapted to the installed disparity barrier, or display the pixels adapted to the installed lenticular lens.

Next, the following description will be concerned with a configuration of diminishing a color difference on the right and left eye video image in the 3D video image display.

FIG. 2 is a block diagram showing a configuration example, in detail, of the left and right color correction processing unit 104 in the first embodiment of the invention. The 3D display video image specified by SBS system, TAB system, FP system, etc. is separated to a left eye video image 201 and a right eye video image 202 in the 3D video image signal processing unit 103 in FIG. 1 to be entered to the left and right color correction processing unit 104 in FIG. 2. For example, in SBS system, the left half of video image decoded in the video image decoder circuit 101 is separated to the left eye video image, and the right half thereof to the right eye video image. Thereafter, the left and right color correction processing unit 104 implements a color analysis for the video images of the left and right.

An L-video image hue histogram analysis unit 203 and an R-video image hue histogram analysis unit 204 in the left and right color correction processing unit 104 implement a color space analysis for the left and right video image. A hue correction processing unit 205 extracts feature parameters (hereinafter, written as feature), such as a peak and hue width of a histogram for the left and right, a barycenter of the histogram, etc. to calculate differences of the feature. Further, a correction for varying the hue of the left and right video image is implemented so that the difference is reduced. In consequence, a left eye video image 206 and a right eye video image 207 both having small hue difference are output.

Here, the following description will be concerned with a hue histogram for use in the processing in the L-video image hue histogram analysis unit 203, R-video image hue histogram analysis unit 204 and hue correction processing unit 205.

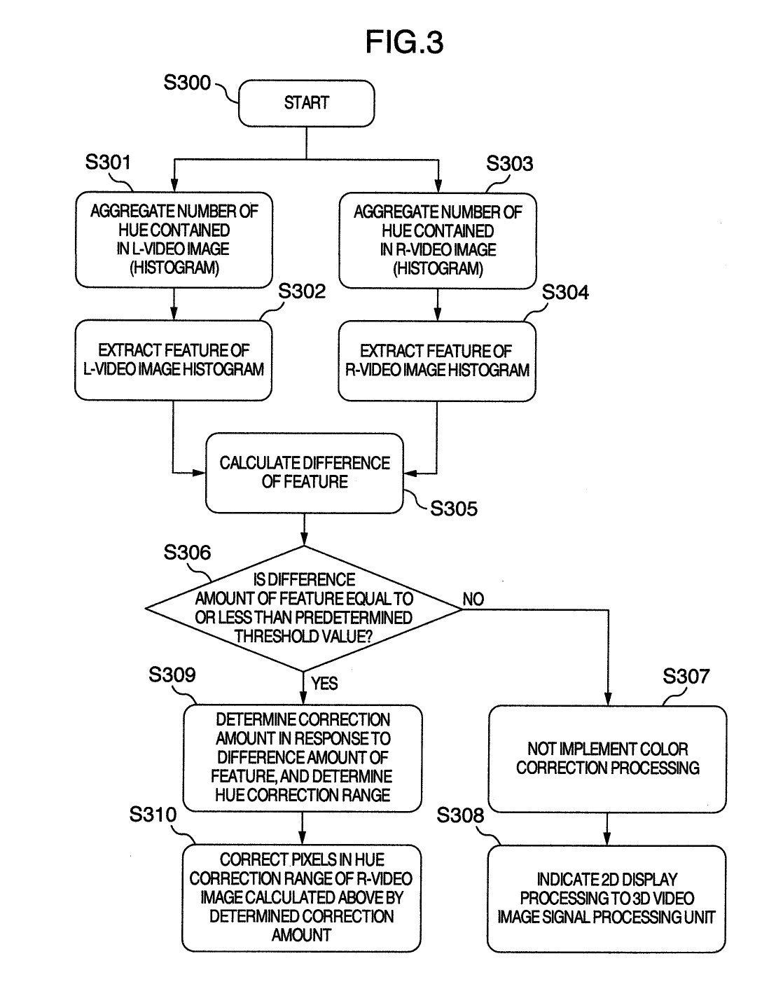

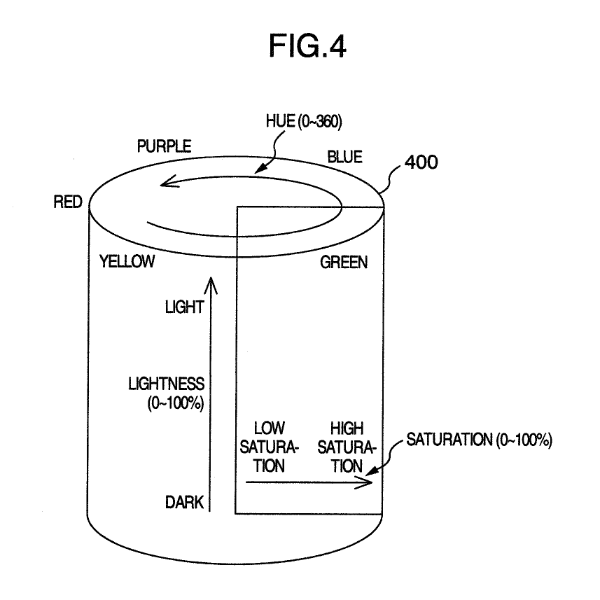

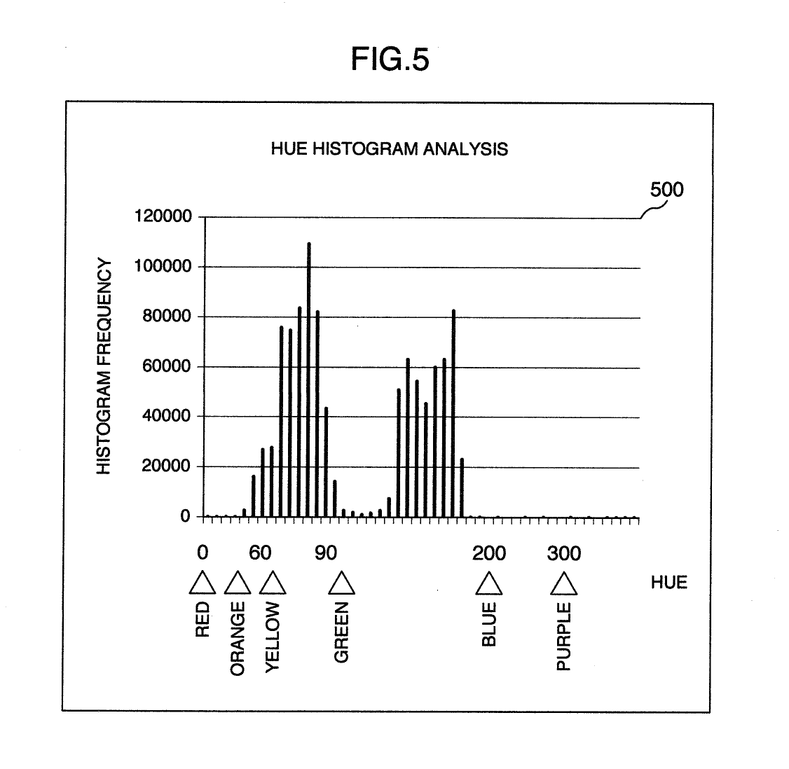

In this embodiment, the hue histogram for the left and right eye video image is calculated in the L-video image hue histogram analysis unit 203, R-video image hue histogram analysis unit 204. First, a definition of a hue value is shown in FIG. 4. One circle on a cylinder in HSV color space represents the hue which varies from red as 0 degree to yellow, green, blue and purple as varied to 360 degrees. The hue is represented by a horizontal axis, and the number of pixels is counted for every hue contained in one screen of the left or right eye video image to make a graphical view, which shows in FIG. 5 as the hue histogram. A hue difference is calculated for the left and right video image by using this hue histogram distribution. The calculation of histogram and hue correction in detail will be described later with reference to FIG. 3.

This embodiment shows an example of the histogram analysis in the hue of HSV color space, however, the hue may be separated into between HSV/HSB color space using, for example, Hue, Saturation/Chroma and Brightness/Lightness/Value to calculate a histogram distribution for each of them as a color analysis. This may use the color analysis for calculating the histogram distribution on axes each representing HLS/HIS color space using Hue, Saturation, Lightness/Luminance or Intensity, various color spaces using CIE color coordinate system (RGB, XYZ, xyY, L*u*v*, L*a*b*), sRGB color triangle, etc.

In this embodiment, of the histogram represented by the axis of hue, saturation and value in HSV color space, the hue histogram is analyzed to make close the histogram features on the left and right video image close to each other. In consequence, the difference of color space is reduced. Not only the hue but also the saturation and value may also be analyzed for the histogram distribution, and a difference amount of the feature is calculated to reduce the difference amount. This processing may be implemented simultaneously with the histogram analysis of the hue and may also be implemented for a time different frame.

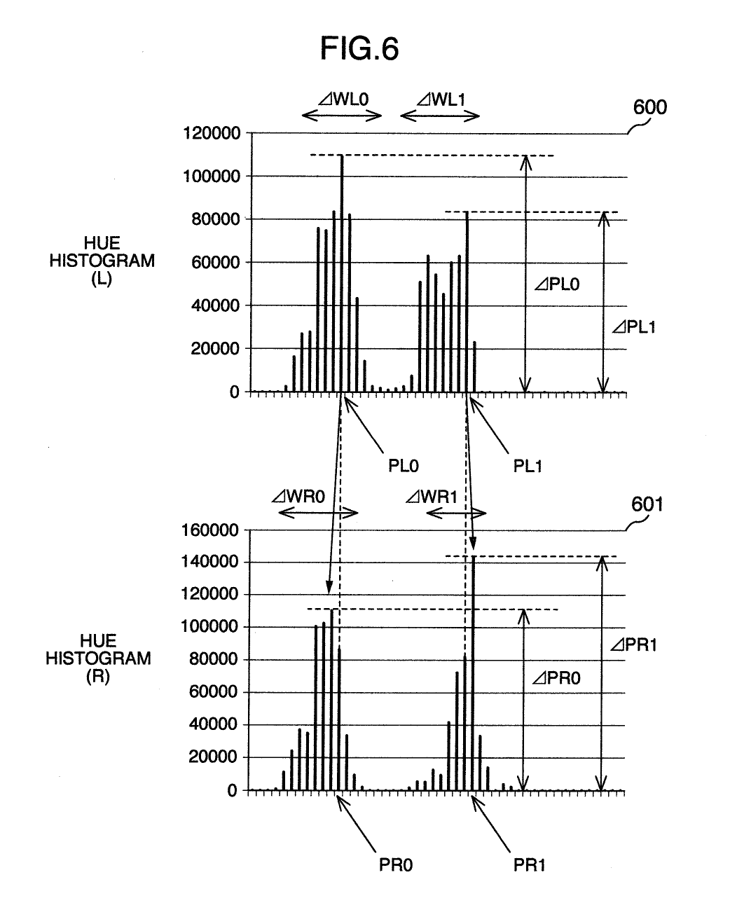

Next, an example of a left and right color correction processing sequence in the left and right color correction processing unit 104 will be described with reference to FIG. 3, FIG. 5, FIG. 6 in the first embodiment.

At a step S300, the video images of the left and right are entered into the left and right color correction processing unit 104 to start a processing. At a step S301, the L-video image hue histogram analysis unit 203 aggregates the number of pixels of the hues contained in the left eye video image. Likewise, at a step S303, the R-video image hue histogram analysis unit 204 aggregates the number of pixels of the hues contained in the right eye video image. At a step S302, the L-video image hue histogram analysis unit 203 detects a hue feature of the left eye video image hue histogram. Here, the hue feature is a peak hue position, a peak hue frequency, a distribution width around the peak hue and a barycenter position of a distribution around the peak hue, or combination of those. FIG. 5 shows an example of the hue histogram aggregated by the L-video image hue histogram analysis unit 203 or R-video image hue histogram analysis unit 204 in the left and right color correction processing unit 104. For example, when the video image represents a blue sky, the histogram emerges around the hue of blue to detect the peak hue, distribution width around the peak hue and the hue at the barycenter around the peak, so that it enable that the hue feature of video image is determined. Likewise, at a step S304, the R-video image hue histogram analysis unit 204 detects the feature of hue histogram on the right eye video image. Next, at a step S305, the hue correction processing unit 205 compares the hue feature of left eye video image with that of the right eye video image. For example, it is calculated that how the peak hue position and peak frequency, distribution width around peak hue, barycenter position of hue distribution around the peak, etc. are deviated, a deviation for each is calculated, and the feature difference is digitalized. At a step S306, the hue correction processing unit 205 determines that the color correction is not implemented at a step S307 when the feature difference amount of histogram distribution calculated at the step S305 is equal to or larger than a predetermined threshold value. In addition to the determination at the step S307, when the feature difference amount is larger than the threshold value from a result of the color analysis for the left and right video image, it may determine that the input video image is not a 3D video image signal. In this case, it may indicate to the 3D video image signal processing unit 103 that the input video image is not separated to the left and right video image at a step S308. At this time, the 3D video image processing device in FIG. 1 implements a 2D video image signal processing.

The following description will be concerned with an advantage of implementing the processing at the step S308. First, when the difference amount of the feature is large at the step S307, there is a probability that the video image is separated forcibly to a half, by setting of the 3D display device, as 3D specified by SBS, TAB, etc. to generate the left and right eye video image and intend displaying 3D display, in the case where the input video image signal is not 3D video image. In this case, a color matching for the left and right video image is not required at the step S307 and the separation to the left and right video image is also not required since the video image is already broken. Consequently, a control, not for implementing the left and right video image separation processing, is indicated to the 3D video image signal processing unit 103 at a step S308.

As a processing when the 3D video image signal processing unit 103 receives the indication of the step S308, the 3D video image single processing unit 103 may output the video image signal output from the video decoder circuit 101 without change as the left eye video image output and right eye video image output, and the 3D display processing unit 105 may implement the same display, i.e. alternately the left and right eye video image, or the left and right video image by line-by-line, as 3D display to realize a 2D display.

As another example of a processing when the 3D video image signal processing unit 103 receives the indication of the step S308, both the 3D video image signal processing unit 103 and the 3D video image color correction processing unit 102 do nothing, the 2D output video image signal from the video image decoder circuit 101 is transmitted to the 3D display processing unit 105 without change, and the output video image signal may be displayed by switching over a display processing setting from the 3D to the 2D display by the 3D display processing unit 105.

At the step S305, it is determined that the video image is entered by an anaglyph system using a red and blue glasses when the difference is a predetermined amount, even though the difference amount is large for the feature of hue histogram, and a processing may be implemented for outputting the left and right video image without implementing the color correction.

When the difference amount of the feature of hue histogram is large, there is a probability that the video image is taken by two cameras of which a focus for the left and right and a white balance are not made match those. In this case, either the left eye or right eye video image is selected in consideration of an eyestrain etc., however, a spatial effect is lost, and the same video image for the left and right may be output to implement a processing for eliminating a color deviation of the video image viewed by the left and right eye.

The threshold value for the difference of left and right video image on the color distribution for determining the anaglyph system mentioned above may be different from the threshold value for the difference of left and right video image on the color distribution depending on the difference of the focus of cameras and white balance. That is, plural threshold values are provided, and they may be switched over in response to the size of difference amount.

FIG. 6 shows an example of the feature of hue histogram on the left and right device in the left and right color correction processing at the step S305. The hue position of hue peak, frequency of peak hue, distribution width, i.e. histogram integrated range, around the peak hue, etc. represent the feature of histogram. Here, the histogram barycenter of a portion into which the histogram is integrated can be calculated by using the histogram frequency and histogram integrated range. FIG. 6 also shows an example of values to be calculated so that the feature of hue histogram is represented. For example, first, the hue positions (PL0, PL1, PR0, PR1) indicating the hue peak of the left eye and right eye video image and the peak frequencies (ΔPL0, ΔPR0, ΔPL1, ΔPR1) of the histogram, are calculated. Further, ranges (ΔWL0, ΔWL1, ΔWR0, ΔWR1) into which the histogram frequency equal to or larger than the threshold value set in the histogram is integrated, is calculated. The difference amount of the feature for the left and right video image is calculated by using the calculated result as the histogram feature. As mentioned above, when the size of feature difference amount of the hue for the left and right video image is determined at the step S306 in FIG. 3, the position difference of the hue peak |PL0−PR0|and |PL1−PR1| may be compared with a predetermined threshold value. The difference of peak frequency |ΔPL0−ΔPR0| and |ΔPL1−ΔPR1| may also be compared with the predetermined threshold value. Further, the difference of histogram integrated range may also be used for the determination.

Next, at a step A309, the difference amount of the feature calculated at the step S305 is determined as a correction amount for the hue. For example, the color deviation (PL0−PR0, PL1−PR1, where PL0, PR0, PL1 and PR1 are a hue position of peak frequencies in the histogram) of the hue peak for the left and right eye video image calculated at the step S305 and the difference of peak frequency (ΔPL0−ΔPR0, ΔPL1−ΔPR1, where ΔPL0, ΔPR0, ΔPL1 and ΔPR1 are a peak frequency of the histogram), are set to as hue correction amount. At the step S309, the range ΔWn (n is integer) into which the histogram frequency equal to or larger than the threshold value set in the histogram is integrated, is calculated to set to as a correction range of the hue correction.

At a step S310, the hue correction processing is implemented for the left and right eye video image in response to the correction amount determined at the step S309. The hue correction for the video image may be applied to one of the video images at least. For example, the hue correction is implemented such that the range of ΔWL0 around the peak hue PR0 on the right eye video image is deviated as the hue, by |ΔPL0−ΔPR0| in the right direction and the range of ΔWL1 around PR1 is deviated as the hue, by |ΔPL1−ΔPR1| in the left direction. In this way, a correction accuracy is increased and an adverse effect caused by the correction can be made small by limiting the correction range to ΔWL0 and ΔWL1 to correct the pixels of hue present in that range.

Further, the pixels in the range of ΔWL0 and ΔWL1 are corrected, and a processing may be implemented to be made match the peak frequency and frequency around the hue.

When the feature of histogram distribution on the left and right video image is made close to each other in accordance with the hue correction mentioned above, the feature of histogram distribution on the right eye video image may be varied to be made close to the feature of histogram distribution on the left eye video image. Conversely, the feature of left eye video image may be varied to be made close to the feature of right eye video image. The average of the feature of histogram distribution on the left eye video image and that of histogram distribution on the right eye video image may be taken to be made close to the average feature of histogram distribution calculated for both the left and right video image.

The above-mentioned processing may be implemented for either every frame or every several frames. When the processing is implemented for every several frames, the same hue correction is implemented for between the several frames, so that a processing load can be reduced.

As a result of the above-mentioned processing, a deviated amount of the hue on the left and right video image is quantified to enable an approach of the hue histogram on the left and right video image in response to the deviated amount.

In addition, the example of hue correction has been described from the above-mentioned processing. However, the color correction for the left and right video image may be implemented for other color spaces in accordance with the difference amount of the color feature for the left and right video image.

In addition, either the left or right eye video image is set to a correction target, is that the video image entering the processing unit later may be set to the correction target. In this case, a preceding entered video image is stored in a line memory, the feature of histogram distribution on the preceding entered video image is analyzed first, and the hue of a succeeding entered video image is then corrected in response to the analyzed result of preceding entered video image. This processing has rather an advantage from a view of the processing in high speed. For example, when the left eye video image is transmitted first in Frame Packing system etc., it is desirable that the hue of right eye video image is matched to the feature of histogram distribution on the left eye video image by using the analyzed result of the feature of histogram distribution on the left eye video image. It is also the same that the received video image is stored in the line memory from the left eye video image in SBS system or TAB system.

As an example of the processing in high speed, in Frame Packing system, the feature of histogram distribution for the preceding entered one eye video image, for example left eye video image, is analyzed, the color correction processing of the right eye video image is implemented for the succeeding entered other eye video image, for example right eye video image. At this time, the feature of histogram distribution for the right eye video image can be analyzed for every one line or several lines by using the histogram analyzed result on the preceding entered left eye video image, as soon as this analysis is ended, the color correction processing can be implemented for the succeeding entered right eye video image in real time. When the histogram analyzed result of the succeeding entered video image, i.e. right eye video image, is applied to the color correction for the preceding entered video image, i.e. left eye video image, the color correction for the succeeding entered video image, i.e. right eye video image, is implemented by using the result of the preceding entered video image, i.e. left eye video image since the display processing is delayed by one frame. This is rather faster than the previous color correction. In also TAB system, likewise, the histogram analysis for the left eye video image is implemented first, and this result is used to thereby be able to correct the right eye video image for every one line. In SBS system, since both the left and right video image are entered onto the one line or several lines in the memory, the processing can be implemented for both the left and right video image simultaneously. By implementing the processing in high speed, the histogram result for the left eye video image is acquired first by counting the pixel from the left. For this reason, the color correction of the pixels to be counted for the last half adapted to that result can be implemented in real time, therefore, it can be made that the processing is implemented in high speed. In TAB system, likewise, the histogram analysis for the preceding entered left eye video image is implemented first, and this result is used to thereby be able to correct the succeeding entered right eye video image for every one line.

In addition, in FIG. 1, the configuration including the video image input I/F 100 to 3D display processing unit 105 may be integrated to configure as a 3D video image processing device and couple with a separate display device having the display unit 106, and the configuration including from the video image input I/F 100 to display unit 106 may be integrated to configure as a 3D display device.

### Embodiment 2

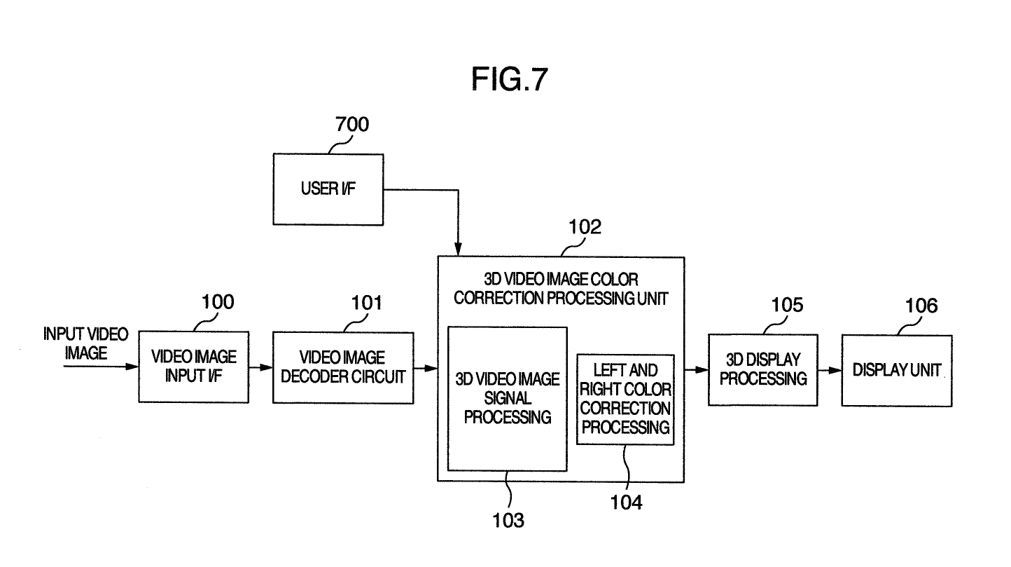

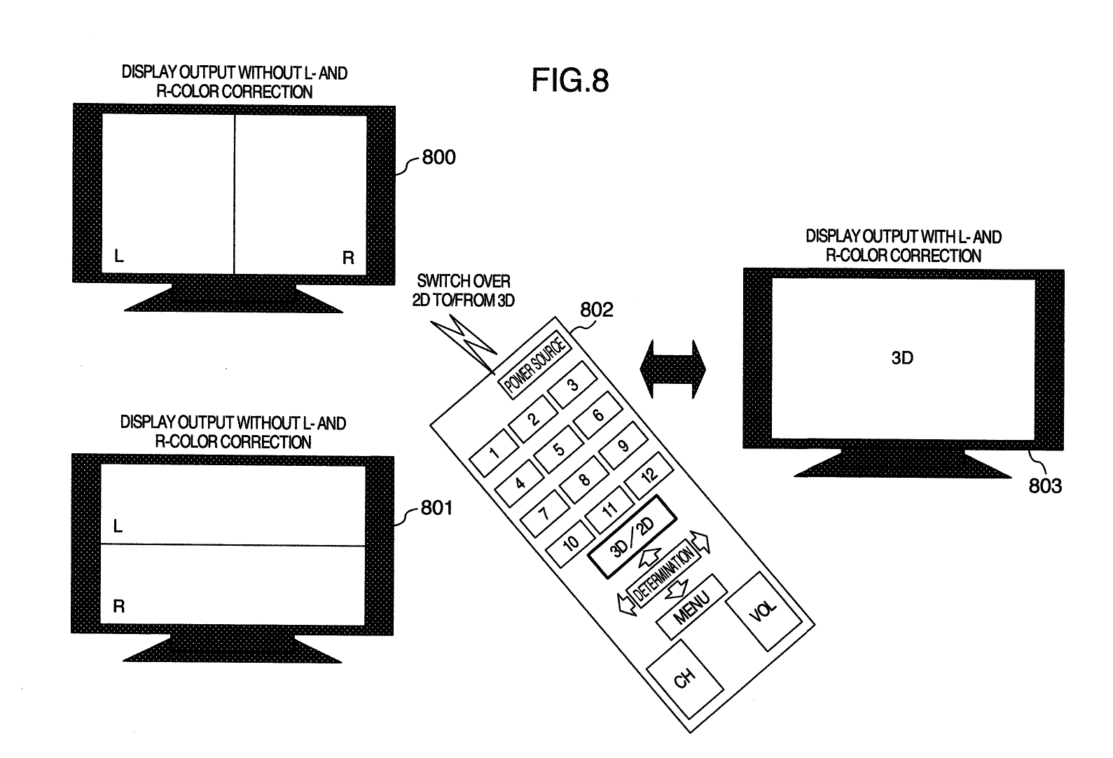

A second embodiment of the invention will be described below with reference to FIG. 7 and FIG. 8. FIG. 7 is a block diagram showing one configuration example of the 3D video image processing device in the second embodiment.

The configuration shown in FIG. 7 includes a user I/F (interface) 700 for receiving a user operation in addition to that shown in FIG. 1. The selection of seeing the 3D video image from the user is detected caused by mounting the user I/F 700, therefore, it enables that the left and right color correction processing is implemented.

FIG. 8 shows an example of coordinating the user operation and the left and right color correction processing. The display unit 106 displays the 3D video image signal, as displayed a display example 800 in FIG. 8, received from a broadcast or a network in SBS system. The 3D video image signal received in TAB system is displayed as a display example 801. Next, when a switching-over indication signal from the 2D to 3D video image is transmitted from a remote control unit 802, the user I/F 700 receives the switching-over indication signal. The user I/F 700 transmits the reception of switching-over indication signal to the 3D video image color correction processing unit 102 to start, at this timing, the left and right color correction processing, so that the video image subjected to the left and right color correction can be seen at a time of displaying the 3D video image. Likewise to an opposing operation, the left and right color correction is already applied at a time of displaying the 3D video image, however, an indication signal from the remote control unit 802 controls such that the left and right color correction processing in the 3D video image color correction processing unit 102 is ended at the timing of switching over to the 2D display.

In this way, it enables to easily determine that the user watches the 3D display, therefore, the determination processing at the step 5306 in the embodiment is unnecessary.

At a time of displaying the 2D display, such as a display example 800 and 801, it can also be checked whether the color deviation etc. to the left or right is present when the video image taken by two cameras unadjusted for a focus, white balance, etc. is seen on the display unit. The left and right color correction is implemented at the timing of switching over to the 3D display by the user, so that a good display characteristic can be provided.

It may be made that the user can select from the following three conditions via the remote control unit 802 and user I/F 700: (1) the color distribution of the left eye video image is corrected to be matched with the color distribution of the right eye video image; (2) the color distribution of the right eye video image is corrected to be matched with the color distribution of the left eye video image; and (3) the color distribution on the left and right video image is matched with the average of the features of color distribution on the left and right video image.

The user I/F 700 may be replaced with a human detecting sensor. For example, when a sensor is used for detecting a human residing in a viewing range by using an infrared light sensor for sensing a body heat emitted from the human body, a camera for sensing a human motion, etc., it enables that the left and right color correction is only implemented for when determining that the human resides close to the device, detected by the sensor, and the left and right color correction is not implemented when the human does not reside. At this time, a condition where the 3D system is installed may be added to the condition where the human resides. From a result of such processing, the left and right color correction can be omitted when the viewer does not reside, so that a processing load can be reduced.

### Embodiment 3

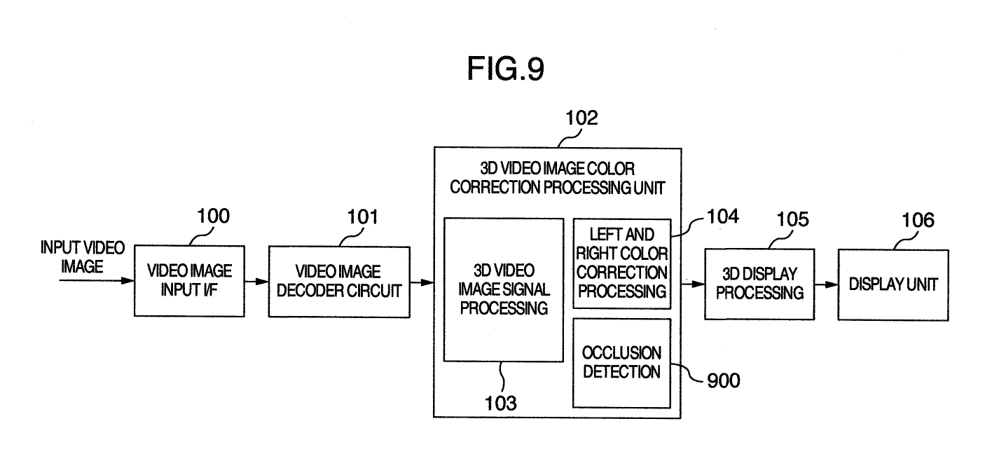

Hereinafter, a third embodiment of the invention will be described with reference to FIG. 9 to FIG. 11.

FIG. 9 is a block diagram showing one configuration example of the 3D display control device in the third embodiment.

The configuration in FIG. 9 includes an occlusion detecting unit 900 in addition to that in FIG. 1. The occlusion detecting unit 900 detects an object not seen from one eye, i.e. observing point, but seen from the other eye, i.e. observing point. The area of occlusion is present only in the video image on one eye but not present in that on the other eye. Therefore, when the occlusion area is calculated as a color difference for the left and right video image, it causes an error component for the hue correction. In consequence, an adverse effect might occur. In this embodiment, the occlusion area is detected to eliminate it from the correction range, and it is made that the occlusion area is not used for the histogram analysis so as not to occur the adverse effect on other portions. In addition, the occlusion detection is realized by detecting an object in the video image, an area of the left and right color difference, etc.

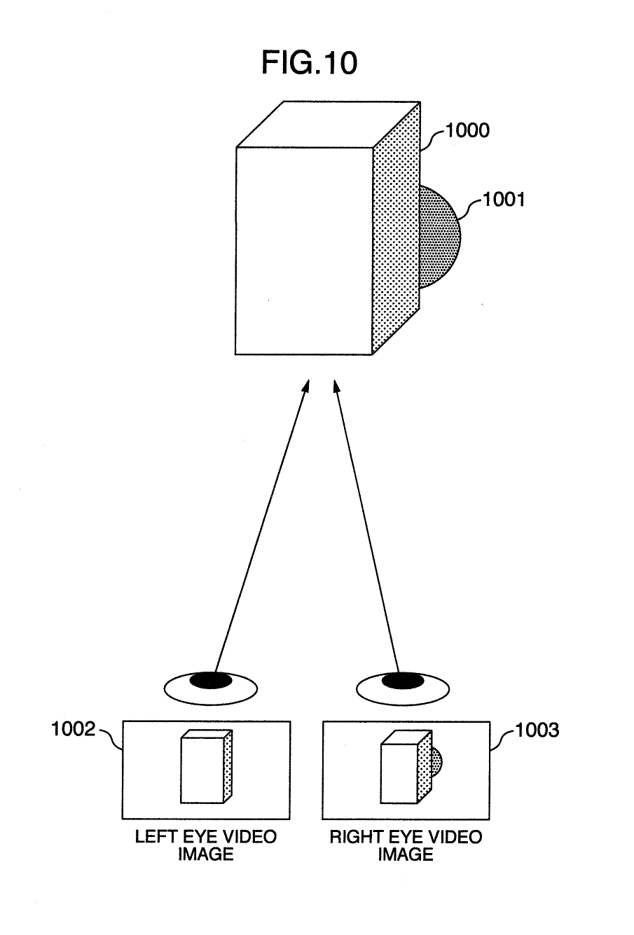

Here, FIG. 10 shows an example of the left and right video image in an occlusion detection processing by the occlusion detecting unit 900 in the third embodiment. FIG. 10 shows a condition where a cube is only seen from the left eye but both the cube and a ball are seen from the right eye, when a cube 1000 and a ball 1001 each having a different color are placed out of alignment. When a picture of these objects is taken by using two cameras corresponding to both eyes, a left eye video image 1002 and right eye video image 1003 are taken as shown in FIG. 10.

The video image taken by the cameras enters the 3D video image processing device to implement the histogram analysis such as hue for the left and right video image etc. In this way, the area having the ball and its color is present in the right eye video image, but not present in the left eye video image, therefore, the difference amount of the histogram feature becomes detected largely. This is however not the difference of hue and this is because an imaging target of the video image is intrinsically different. It is apparent that this is not the left and right color difference caused by a difference of the focus on cameras and white balance.

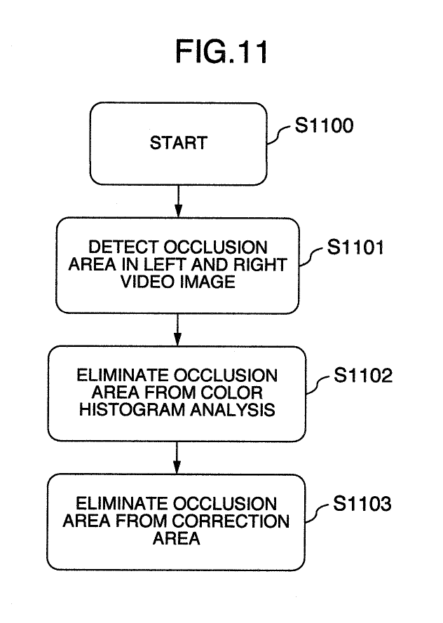

FIG. 11 is an operation sequence showing the occlusion detection in the 3D video image processing device in the third embodiment.

The processing starts at a step S1100. The occlusion area in the left and right video image is detected at a step S1101. At a step S1102, the occlusion area is set to elimination from the histogram analysis. Next, at a step S1103, the occlusion area is eliminated from the left and right color correction area. The operation in FIG. 11 may be coordinated with the processing of the left and right color correction processing unit 104 in the occlusion detecting unit 900. At this time, it is required to implement the processing at the step S1101 in FIG. 11 earlier than the processing at the steps S301, S302 in FIG. 3 so that the occlusion area is set to eliminate from the histogram analysis. At the step S1102 in FIG. 11, the processing is coordinated with that at the steps S301, S302 to eliminate a portion of number in the occlusion area from an aggregate processing of the histogram at the steps 301, S302. At the step S1103 in FIG. 11, the processing is coordinated with that at the step S309 in FIG. 3 to eliminate the occlusion area from the correction range at the step S309.

From the processing mentioned above, it enables that the left and right video image color correction other than the occlusion area is implemented without subjecting to the adverse effect of the color in the occlusion area. Further, there is a merit that the correction is unnecessary for the color in the occlusion area only relative to one eye.

### Embodiment 4

A fourth embodiment of the invention will be described below.

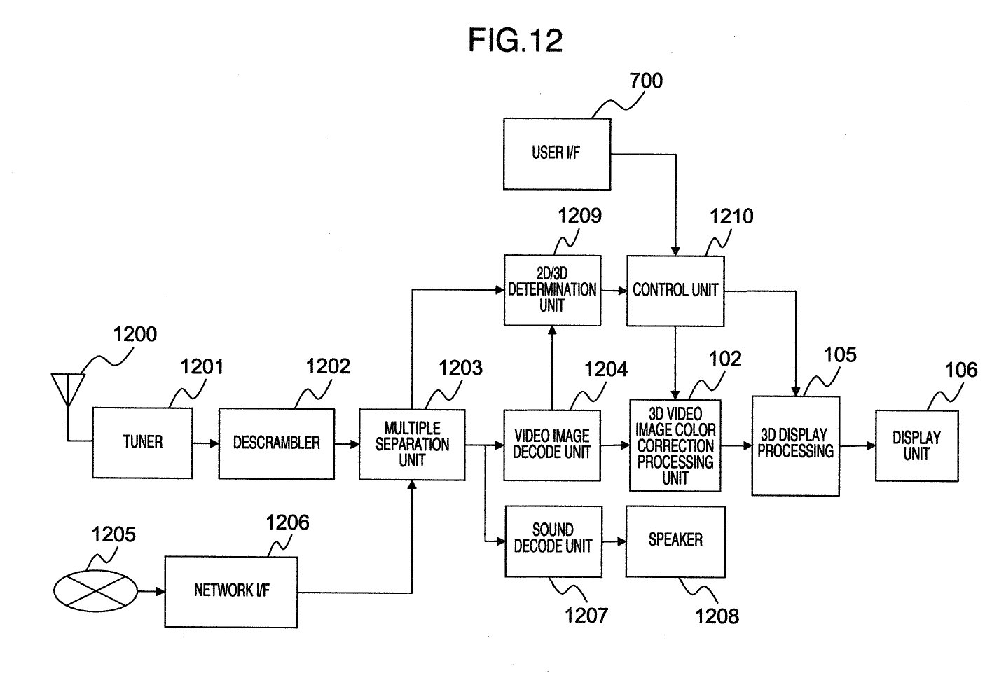

FIG. 12 is a diagram showing a configuration example of a receiving device in the fourth embodiment. A description is omitted for elements in FIG. 12 designating the same reference numerals as those in FIG. 1 or FIG. 7, therefore, a description for configuration and operation for those are also omitted. The configuration and operation different from FIG. 1 or FIG. 7 will be described below.

An antenna 1200 receives a broadcasting signal via a wireless broadcast wave (satellite broadcasting, terrestrial broadcasting) or wire broadcasting transmission network such as a cable, and a tuner 1201 tunes in a specific frequency to implement demodulation, error correction processing, etc. When the broadcasting signal is scrambled, a descrambler 1202 decodes a scramble signal. By the processing mentioned above, a multiplexed signal is restored to enter a multiple separation unit 1203. The multiple separation unit 1203 separates a signal multiplexed to a format, such as MPEG2-TS (Transport Stream) etc. to a signal, such as a video image ES (Elementary Stream), sound ES, program information, etc. ES means compressed and encoded image/sound data. A video decode unit 1204 decodes the video image ES into a video image signal to be output to the 3D video image color correction processing unit 102. The 3D video image color correction processing unit 102 implements the color correction controlled by a control unit 1210. The processing of color correction is the same as described in the above-mentioned embodiments. The video image output from the 3D video image color correction processing unit 102 is subjected to the 3D display processing in the 3D display processing unit 105 to display as 3D display on the display unit 106, when the 3D video image is displayed as 3D video image. When the 2D video image is displayed as 2D display, the 3D display processing is not implemented by the 3D processing unit 105, the 2D video image is displayed on the display unit 106. When the 3D video image is displayed as 2D display, the 3D display processing unit 105 may output, as 2D video image, the video image of one observing point (for example, video image of either the left or right eye video image in the case of SBS system) contained in the 3D video image to be displayed as the 2D display on the display unit 106. When the 2D video image is displayed as 3D display, the 3D display processing unit 105 may implement a 2D-3D video image conversion processing to be converted from the 2D into 3D video image to output as 3D video image and display as 3D display on the display unit 106. Various methods of the 2D-3D conversion processing have been known, therefore, either method of the 2D or 3D conversion processing function may be incorporated in the 3D display processing unit 105. The control unit 1210 controls the 3D display processing for the 3D display processing unit 105. A sound decode unit 1207 decodes the sound ES into a sound signal to output externally as an output or a sound output to a speaker 1208. A network 1205 is Internet or a network group as infrastructure. A network I/F 1206 transmits and receives information via the network, that is, transmits and receives various information and MPEG2-TS etc. between Internet and the receiving device. The video image and sound entered into the multiple separation unit 1203 may enter the receiving device via the tuner 1201 or the network I/F 1206.

A 2D/3D determination unit 1209 determines whether the video image is the 3D or 2D video image by using 3D/2D identification information, indicating whether it is 3D video image contents, contained in the information received from the antenna 1200 and network I/F 1206, and 3D system identification information, indicating the system of 3D video image, such as SBS, TAB, Frame Packing, etc.

It can be considered that there are various transmission methods for the 3D/2D identification information and 3D system identification information. For example, it can be considered to be stored as program information, i.e. program specific information and program service information, contained in MPEG2-TS (Transport Stream) and separated by the multiple separation unit 1203. The program specific information (PSI) is required for selecting a predetermined program, including encode information of video image, encode information of sound and program composition. The program service information (SI) is various information ruled in convenience for selecting the program, including PSI information of MPEG-2 system specification having EIT (Event Information Table) containing information regarding the program, such as a program name, a broadcast date and time, a program contents, etc., and SDT (Service Description Table) containing information regarding an organization channel (service), such as an organization channel name, broadcast business operator name, etc. The 3D/2D identification information may be stored in a descriptor ruled by PSI or SI or a newly added descriptor. The 3D/2D identification information and 3D system identification information are stored in these descriptors, therefore, it enables to identify whether the information is of the 3D program contents with a program unit and is of the 3D program service with a service unit.

It may be configured such that the 3D/2D identification information is appended to the video image ES at a step of encoding the video image. For example, when the video image encoding system is MPEG2 system, an encoding may be implemented such that the above-mentioned 3D/2D identification information and 3D system identification information are appended to a user data area succeeding to a Picture header and Picture Coding Extension. In this case, the video image decode unit 1204 can recognize a 3D identification flag in a frame , or picture, unit of the video image and can also identify an event even when the 2D video image is inserted into on the way of the 3D video image stream.

The 2D/3D determination unit 1209 determines whether the video image is the 3D or 2D video image by using the 3D/2D identification information and 3D system identification information separated in the multiple separation unit 1203 or extracted in the video image decode unit 1204, as mentioned above. In response to a determined result from the 2D/3D determination unit 1209, the control unit 1210 controls the color correction in the 3D video image color correction processing unit 102.

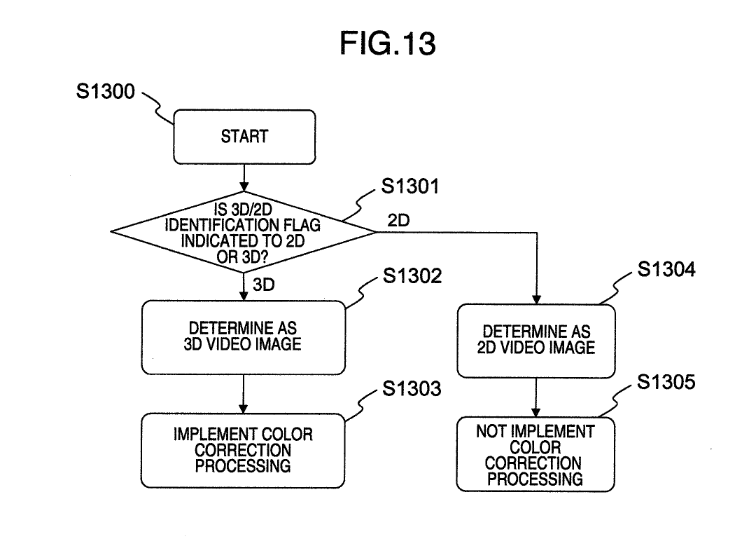

Here, FIG. 13 shows an example of an operation sequence of the 2D/3D determination unit 1209 and control unit 1210. First, a determination processing starts at a step S1300. If the received 3D/2D identification information indicates the 3D video image at a step S1301, the 2D/3D determination unit 1209 determines that an input video image is the 3D video image at a step S1302, and the control unit 1210 controls so as to implement the color correction processing for the left and right video image in the 3D video image color correction processing unit 102 at a step S 1303. If the received 3D/2D identification information indicates the 2D video image at the step S1301, the 2D/3D determination unit 1209 determines that the input video image is the 2D video image at a step S1304, and the control unit 1210 controls so as not to implement the color correction processing for the left and right video image in the 3D video image color correction processing unit 102 at a step S 1305. In this way, it enables that the color correction for the left and right video image is implemented automatically on the basis of the 3D information contained in the received information by the 3D display device in viewing the video image.

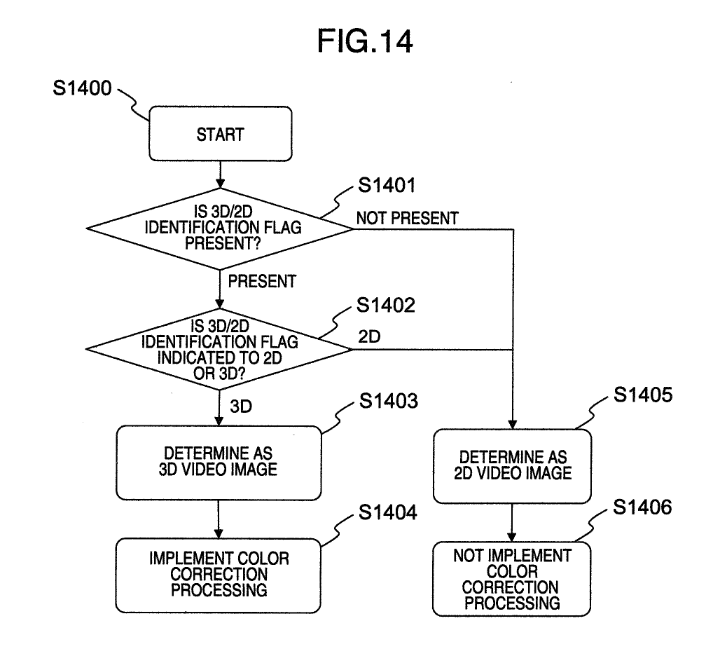

FIG. 14 shows another example of an operation sequence of the 2D/3D determination unit 1209 and control unit 1210. FIG. 14 contains a determination of the case where the 3D/2D identification information of a processing targeted program is not contained in the received signal in the operation sequence of FIG. 13. First, the determination processing starts at a step S1400. If the 3D/2D identification information of the processing targeted program is not contained in the received signal at a step S1401, the 2D/3D determination unit 1209 determines that the processing targeted program is the 2D video image program at a step S1405, and the control unit 1210 controls so as not to implement the color correction processing for the left and right video image in the 3D video image color correction processing unit 102 at a step S1406. If the 3D/2D identification information of the processing targeted program is contained in the received signal at the step S1401, the processing proceeds to a step S1402. If the 3D/2D identification information of the processing targeted program contained in the received signal indicates the 3D video image at the step S1402, the 2D/3D determination unit 1209 determines that the processing targeted program is the 3D video image program at a step S1403, and the control unit 1210 controls so as to implement the color correction processing for the left and right video image in the 3D video image color correction processing unit 102 at a step S 1404. If the 3D/2D identification information of the processing targeted program contained in the received signal indicates the 2D video image at the step S1402, the 2D/3D determination unit 1209 determines that the processing targeted program is the 2D video image program at the step S1405, and the control unit 1210 controls so as not to implement the color correction processing for the left and right video image in the 3D video image color correction processing unit 102 at the step S1406. In this way, even when the 3D/2D identification information is missed from the received signal without intending from a transmission side, it can be prevented that an inappropriate display is implemented by the color correction caused by the receiving device.

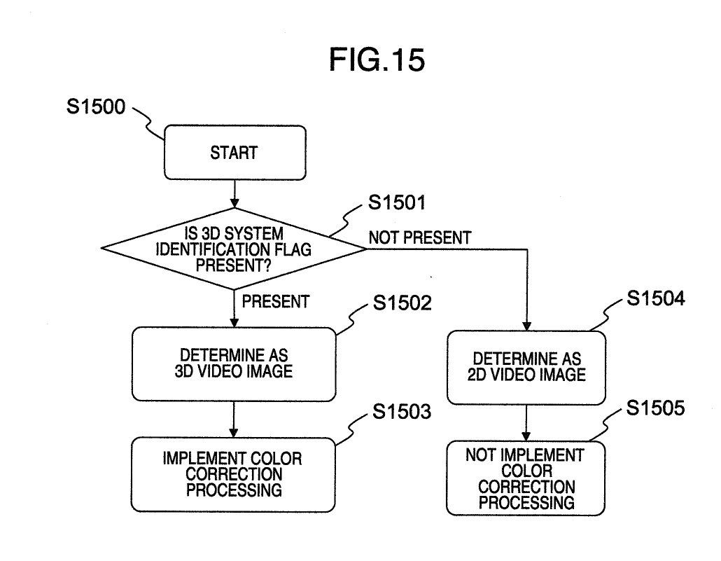

FIG. 15 shows another example of the operation sequence for the 2D/3D determination unit 1209 and control unit 1210. The 2D/3D determination unit 1209 implements the determination in accordance with the operation sequence in FIG. 15, by using the 3D system identification information indicating the 3D system, such as SBS, TAB, Frame Packing, etc. First, the determination processing starts at a step S1500. If the 3D system identification information of the processing targeted program is contained in the receiving signal at a step S1501, the 2D/3D determination unit 1209 determines that the input video image is the 3D video image at a step S1502, and the control unit 1210 controls so as to implement the color correction processing for the left and right video image in the 3D video image color correction processing unit 102 at a step S1503. If the 3D system identification information of the processing targeted program is not contained in the receiving signal at the step S1501, the 2D/3D determination unit 1209 determines that the input video image is the 2D video image at a step S1504, and the control unit 1210 controls so as not to implement the color correction processing for the left and right video image in the 3D video image color correction processing unit 102 at a step S1505. In this way, it enables that a necessity of the color correction processing for the left and right video image is controlled in response to presence or absence of the 3D system identification information indicating the system, or format, of the 3D video image.

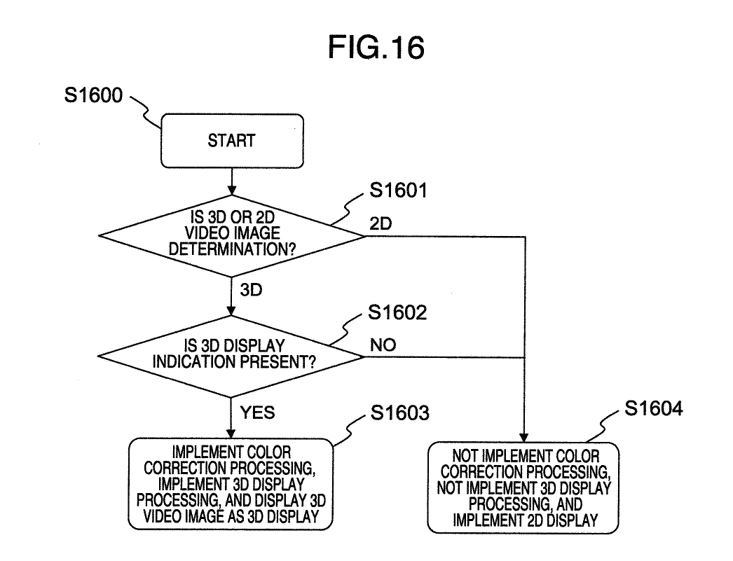

A timing for starting and stopping the color correction processing for the left and right video image in the invention may be a timing when the 3D or 2D video image was identified, in response to the above-mentioned method, and the method of identification may be used of either one mentioned above. It may be configured that the control unit 1210 determines the processing by combining the determined result in the 2D/3D determination unit 1209 and a user operated signal entered from the user I/F 700. For example, the processing may be configured such that the 3D display processing and the left and right color correction processing are not implemented until the 3D display indication is accepted via the user I/F 700, even when the 2D/3D determination unit 1209 determined that the input video image is the 3D video image. An operation sequence of the 2D/3D determination unit 1209, user I/F 700 and control unit 1210 for the above-mentioned case will be described with reference to FIG. 16, as one example. First, the determination processing starts at a step S 1600. The 2D/3D determination unit 1209 determines whether the input video image is the 3D video image at a step S1601. Here, the determination processing in the 2D/3D determination unit 1209 at the step S 1601 may use of either determination processing shown in FIG. 13, FIG. 14 or FIG. 15, and other determination processing may also be acceptable. If the 2D/3D determination unit 1209 determines that the input video image is the 2D video image at the step S1601, the control unit 1210 controls so as not to implement the color correction processing for the left and right video image in the 3D video image color correction processing unit 102, and also controls so as not to implement the video image processing for the 3D display in the 3D display processing unit 105 at a step S 1604. At the step S1604, the 2D video image is displayed as 2D display. If the 2D/3D determination unit 1209 determines that the input video image is the 3D video image at the step S1601, the processing proceeds to a step S1602. Here, if the 3D display indication signal is not entered yet from the user via the user I/F 700 at the step S1602, the control unit 1210 controls so as not to implement the color correction processing for the left and right video image in the 3D video image color correction processing unit 102, and controls so as not to implement the video image processing for the 3D display in the 3D display processing unit 105 at the step S1604. At the step S1604, the 3D video image is displayed as 2D display, however, one video image in the 3D video image may be displayed as 2D display at this time. For example, in the 3D video image of the system in which plural observing points are stored in one screen of the 2D image specified by SBS, TAB, etc., the screen storing the plural observing points may be displayed as 2D video image without change. If the 3D display indication signal is already entered from the user via the user I/F 700 at the step S1602, the control unit 1210 controls so as to implement the color correction processing for the left and right video image in the 3D video image color correction processing unit 102, and also controls so as to implement the video image processing for the 3D display in the 3D video image processing unit 105 at a step S1603. At the step S1603, the 3D video image is displayed as 3D display. From the above-mentioned operation, the color correction processing for the left and right video image in the 3D video image color correction processing unit 102 can be omitted until it is checked that the user intends to display the 3D video image, and the 3D video image having less color deviation and safety can be seen, after checking that the user intends to display the 3D display. In addition, when the 3D system identification information, indicating a 3D format specified by SBS, TAB, Frame Packing, etc., is contained in the receiving signal, the color correction processing for the left and right video image appropriate to the format indicated by the identification information may be implemented when the user operated for the 3D display.

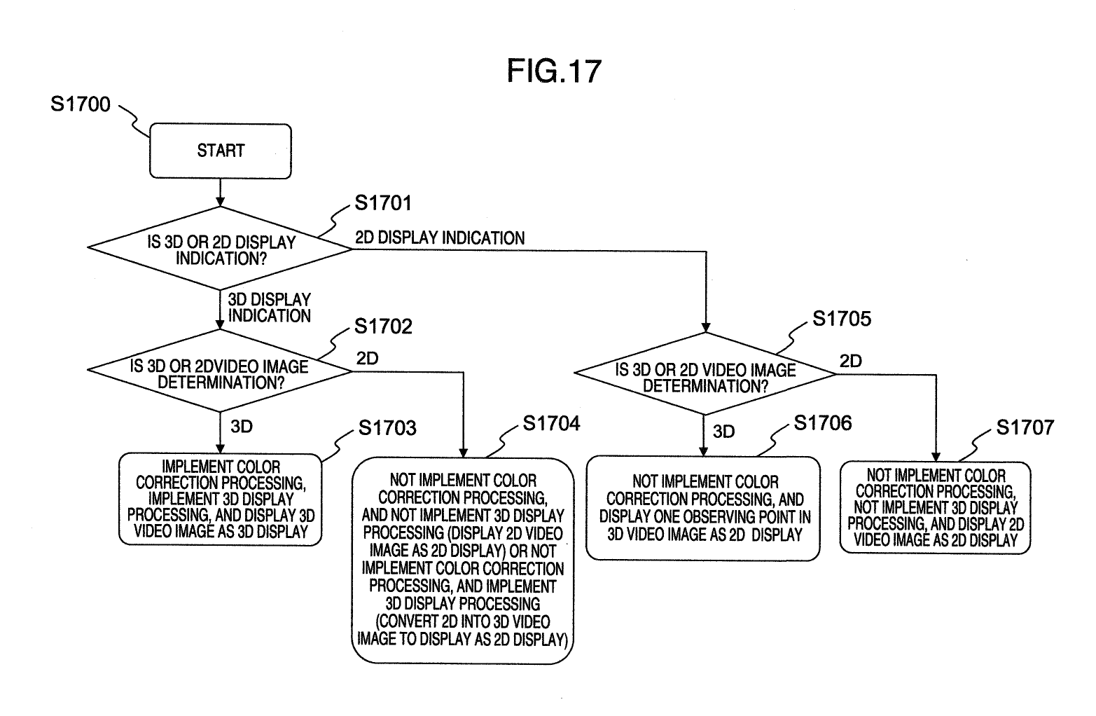

The color correction processing for the left and right video image may not be implemented when the video image is identified as the 2D video image, even though the information indicating the 3D display is entered via the user I/F 700. An example of an operation sequence for a 2D/3D determination unit 1209, user I/F 700 and control unit 1210 for the above-mentioned case will be described with reference to FIG. 17. First, the determination processing starts at a step S1700. If the 3D display indication signal is entered from the user via the user I/F 700 at a step S1701, the processing proceeds to a step S1702. The 2D/3D determination unit 1209 determines whether the input video image is the 3D video image at the step S1702. Here, the determination processing of the 2D/3D determination unit 1209 at the step S1702 may use that of either the determination unit 1209 shown in FIG. 13, FIG. 14 or FIG. 15. If the 2D/3D determination unit 1209 determines that the input video image is the 3D video image at the step S1702, the control unit 1210 controls so as to implement the color correction processing for the left and right video image in the 3D video image color correction processing unit 102, and also controls so as to implement the video image processing for the 3D display in the 3D display processing unit 105 at a step S1703. At the step S1703, the 3D video image is displayed as 3D display. Here, if the 2D/3D determination unit 1209 determines that the input video image is the 2D video image at the step S1702, the processing proceeds to a step S1704. At the step S1704, it is considered that there are two ways for the control. In a first way control, the control unit 1210 controls so as not to implement the color correction processing for the left and right video image in the 3D video image color correction processing unit 102, and controls so as not to implement the video image processing for the 3D display in the 3D display processing unit 105. In this case, the 2D video image is displayed as 2D display. In a second way control, the control unit 1210 controls so as not to implement the color correction processing for the left and right video image in the 3D video image color correction processing unit 102, and controls so as to implement the 2D/3D conversion processing for converting the 2D to 3D video image in the 3D display processing unit 105. In this case, the 2D video image is converted into 3D video image to display as 3D display. In addition, it may be used whether the first or second way control is selected appropriately when using the 3D display device. It may also be configured such that the user can set selectively the first or second way control in setting a menu, in advance. Next, at the step S1701, if the 2D display indication signal is entered from the user via the user I/F 700, the processing proceeds to a step S1705. If the 2D/3D determination unit 1209 determines that the input video image is 3D video image at the step S1705, the control unit 1210 controls so as to implement the color correction processing for the left and right video image in the 3D video image color correction processing unit 102, and controls so as to output the video image of one observing point in the 3D video image as 2D video image in the 3D display processing unit 105 at a step S1706. At the step S1706, the video image of one observing point in the 3D video image is displayed as 2D display. At the step S1705, if the 2D/3D determination unit 1209 determines that the input video image is 2D video image, the control unit 1210 controls so as not to implement the color correction processing for the left and right video image in the 3D video image color correction processing unit 102, and controls so as not to implement the video image processing for 3D display in the 3D display processing unit 105 at a step S1707. At the step S1707, the 2D video image is displayed as 2D display. From the operation mentioned above, the On/Off for the left and right color correction processing and 2D/3D display processing can be implemented more preferably in response to the identification for the 2D or 3D video image and the user operated signal.

In the above-mentioned embodiments, the same processing can be implemented for the 3D display system of either a liquid crystal shutter system, polarization glasses system or glasses-free system.

The program to be executed in the 3D display control device may be incorporated therein, provided as a recording medium recording it, and provided to download it via a network.

In addition, the embodiments have described for the hue analysis and its correction. However, the analysis and correction are not limited to apply to the hue. The color correction for the left and right video image may be implemented for the saturation, value, brightness, etc. in response to the difference amount of the color feature on the left and right video image. The analysis and correction may also be implemented in parallel with plural color spaces, among of the plural color spaces of the hue, saturation, value, brightness, etc.

It should be further understood by those skilled in the art that although the foregoing description has been made on embodiments of the invention, the invention is not limited thereto and various changes and modifications may be made without departing from the spirit of the invention and the scope of the appended claims.

1. A three-dimensional video image processing device, comprising:
an input unit which receives a video image;
an analysis unit which generates a histogram of a color space for each of a left and right eye video image contained in the video image to detect a feature parameter for each of the video images; and
a correction unit which implements a correction on the color space, for reducing a difference of the feature parameter of the left eye video image and the feature parameter of the right eye video image detected in the analysis unit.

2. The device according to claim 1 wherein
a correction processing in the correction unit is implemented when the difference of the feature parameter of the left eye video image and the feature parameter of the right eye video image detected in the analysis unit is equal to or less than a predetermined threshold value.

3. The device according to claim 2 wherein
the correction unit does not implement the color correction when the difference of the feature parameter of the left eye video image and the feature parameter of the right eye video image detected in the analysis unit is larger than the predetermined threshold value.

4. The device according to claim 3 further comprising a three-dimensional video image processing unit which selectively implements a three-dimensional video image signal processing and a two-dimensional video image signal processing for the received video image wherein
the signal processing in the three-dimensional video image processing unit is switched over to the signal processing for the two-dimensional video image when the difference of the feature parameter of the left eye video image and the feature parameter of the right eye video image detected in the analysis unit is larger than the predetermined threshold value.

5. The device according to claim 1 further comprising a user interface wherein
the correction unit starts to implement the correction on the color space when the user interface receives a switching-over indication from a two- to a three-dimensional display.

6. The device according to claim 5 wherein
the correction unit ends the correction on the color space when the user interface receives the switching-over indication from the three- to the two-dimensional display.

7. The device according to claim 1 further comprising a human detecting sensor wherein
the correction unit implements the correction on the color space when the human detecting sensor detects that a human resides, and does not implement the correction on the color space when the human detecting sensor detects that the human does not reside.

8. The device according to claim 1 further comprising an occlusion detecting unit wherein
the occlusion detecting unit detects an occlusion area existing an object not seen from one observing point but seen from the other observing point in the left and right eye video image contained in the received video image,
the analysis unit eliminates the occlusion area in a generation processing of the histogram of the color space, and
the correction unit eliminates the occlusion area from a correction target on the color space.

9. The device according to claim 1 wherein
the feature parameter detected by the analysis unit includes a peak position of the histogram of the color space on the video image, a frequency in the peak position, a distribution width around the peak position or a barycenter of a distribution around the peak position.

10. The device according to claim 9 wherein
the correction on the color space in the correction unit is a correction of making the peak positions of the left and right eye video image, the frequency in the peak positions, the distribution width around the peak positions or the barycenter of the distribution around the peak positions close to each other.

11. The device according to any one of claim 1 further comprising a display unit.

12. A three-dimensional video image processing method, comprising:
an input step of receiving a video image;
an analysis step of generating a histogram of a color space for each of a left and right eye video image contained in the received video image to detect a feature parameter for each of the video images; and
a correction step of implementing a correction on the color space, for reducing a difference of the feature parameter of the left eye video image and the feature parameter of the right eye video image detected in the analysis step.

13. The method according to claim 12 wherein
the difference of the feature parameter of the left eye video image and the feature parameter of the right eye video image detected in the analysis step is compared with a predetermined threshold value, and a correction processing in the correction step is switched over whether the correction processing is implemented in response to a compared result.

14. The method according to claim 12 wherein
a correction processing in the correction step is switched over whether the correction processing is implemented in coordination with a switching-over indication of two-and three-dimensional display from a user.

15. The method according to claim 12 wherein
a correction processing in the correction step is switched over whether the correction processing is implemented in response to a detected result of a human detecting sensor.

16. The method according to claim 12 further comprising an occlusion detecting step of detecting an occlusion area for the left and right eye video image, wherein
the occlusion area detected by the occlusion detecting step is eliminated from the generation of the histogram in the analysis step, and also eliminated from a correction target in the correction step.

17. A three-dimensional video image processing device, comprising:
an input unit which receives a video image;
a user interface which receives an operation entered signal from a user; and
a correction unit which implements a correction to make colors of a left and right eye video image close to each other when the left and right eye video image is contained in the received video image, wherein
the correction in the correction unit is controlled in response to the operation entered signal received by the user interface.

18. The device according to claim 17 wherein
the correction in the correction unit starts when the user interface receives the operation entered signal for switching over from a two- to a three-dimensional display.

19. The device according to claim 18 wherein
the correction in the correction unit ends when the user interface receives the operation entered signal for switching over from the three- to the two-dimensional display.

20. The device according to claim 17 wherein
the correction in the correction unit switches over to either the color of the left eye video image is corrected to be made close to the color of the right eye video image, the color of the right eye video image is corrected to be made close to the color of the left eye video image, or the color of the right and left eye video image is corrected to be made close to an average of the color of the right and left eye video image, in response to the operation entered signal received by the user interface.

21. The device according to claim 17 further comprising a human detecting sensor wherein
the correction unit implements the correction when a human detecting sensor detects that a human resides, and does not implement the correction when the human detecting sensor detects that the human does not reside.

22. The device according to claim 17 further comprising a human detecting sensor wherein
the correction unit implements the correction when the human detecting sensor detects that the human resides and a three-dimensional display is set by the user interface, and does not implement the correction when the human detecting sensor detects that the human does not reside and the three-dimensional display is not set by the user interface.

23. A receiving device, comprising:
a receiving unit which receives a video image information and identification information containing information for identifying whether the video image is a two- or three-dimensional video image;
a determination unit which determines whether the received video image is the two- or three-dimensional video image; and
a correction unit which implements a correction to make colors of a left and right eye video image of the received three-dimensional video image close to each other.

24. The device according to claim 23 wherein
the correction unit implements the correction to make the colors of the left and right eye video image of the three-dimensional video image close to each other when the determination unit determines that the received video image is the three-dimensional video image in accordance with the identification information received by the receiving unit.

25. The device according to claim 23 wherein
the identification information is information for identifying whether the received video image is the two- or three-dimensional video image with a program unit, and the determination unit determines that the video image of the program not containing the identification information in the information received by the receiving unit is the two-dimensional video image.

26. The device according to claim 23 further comprising a user interface for receiving an operation entered signal from a user wherein
the correction unit does not implement the correction to make the colors of the left and right eye video image in a three-dimensional program contents close to each other until operation information for indicating a three-dimensional display is entered from the user interface, even when the determination unit determines that a received program contents is a three-dimensional program contents in accordance with the identification information received by the receiving unit.

27. The device according to claim 23 further comprising a user interface for receiving an operation entered signal from a user wherein
the correction unit does not implement to make the colors of the left and right eye video image in a three-dimensional program contents close to each other when the determination unit determines that a received program contents is a two-dimensional program contents in accordance with the identification information received by the receiving unit, even when operation information for indicating a three-dimensional display is entered from the user interface.
